(19) United States
(12) Patent Application Publication
(10) Pub. No.: US 2025/0263124 A1
(43) Pub. Date: Aug. 21, 2025

(54) VEHICLE BODY FRONT STRUCTURE

(71) Applicant: TOYOTA JIDOSHA KABUSHIKI KAISHA, Toyota-shi (JP)

(72) Inventor: Satoru ABE, Okazaki-shi (JP)

(73) Assignee: TOYOTA JIDOSHA KABUSHIKI KAISHA, Toyota-shi (JP)

(21) Appl. No.: 18/944,715

(22) Filed: Nov. 12, 2024

(30) Foreign Application Priority Data
Feb. 20, 2024 (JP) 2024-024062

(51) Int. Cl. B62D 21/15; B62D 25/08

(52) U.S. Cl. CPC B62D 21/152; B62D 25/085

(57) ABSTRACT

The vehicle includes a motor, a bulkhead portion constituting a part of a front part formed as a metal casting and partitioning the vehicle cabin and the power unit room on a vehicle rear side of the motor, a front mount portion which supports a vehicle front side portion of the motor with respect to the front part and is capable of releasing a support state of the motor when a load of a predetermined size or more is input from the vehicle front side, a rear mount portion which supports a vehicle rear side portion of the front mount portion and the vehicle upper side of the motor with respect to the front part, and an impact absorbing portion which is integrally provided with the bulkhead portion on the vehicle front side of the bulkhead portion and deforms when an impact load from the vehicle front side is input.

### CROSS-REFERENCE TO RELATED APPLICATION

This application claims priority to Japanese Patent Application No. 2024-024062 filed on Feb. 20, 2024, incorporated herein by reference in its entirety.

### BACKGROUND

### 1. Technical Field

The present disclosure relates to vehicle body front structures.

### 2. Description of Related Art

Japanese Unexamined Patent Application Publication No. 2021-75159 (JP 2021-75159 A) discloses an embodiment related to a vehicle rear structure. In this vehicle rear structure, a muffler located behind a motor is crushed by the motor in the event of a rear-end collision. The muffler can thus absorb impact energy of the motor.

### SUMMARY

However, the above related art does not mention absorbing impact energy of a motor in the event of a frontal collision of a vehicle in which the motor is mounted on the front side of the vehicle, and there is room for improvement in this respect.

In view of the above circumstances, an object of the present disclosure is to provide a vehicle body front structure that can absorb impact energy of a motor in the event of a frontal collision of a vehicle in which the motor is mounted on the front side of the vehicle.

A vehicle body front structure of a first aspect includes:
a motor disposed on a front side of a vehicle and configured to apply a driving force to a drive wheel;
a bulkhead portion constituting part of a vehicle body that is a metal cast product, and separating a vehicle cabin and a power unit room from each other at a position behind the motor in a vehicle front-rear direction;
a front mount portion configured to support a front part in the vehicle front-rear direction of the motor with respect to the vehicle body, and configured to release the motor from a supported state when a load of a predetermined magnitude or more is applied from the front side of the vehicle;
a rear mount portion configured to support a rear part in the vehicle front-rear direction of the motor with respect to the vehicle body at a position behind the front mount portion in the vehicle front-rear direction and above the front mount portion in a vehicle up-down direction; and
an impact absorbing portion that is provided integrally with the bulkhead portion on a front side in the vehicle front-rear direction of the bulkhead portion and that is configured to be deformed when an impact load is applied from the front side of the vehicle.

In the vehicle body front structure of the first aspect, the motor is disposed on the front side of the vehicle, and the motor applies the driving force to the drive wheel of the vehicle. The vehicle body that is a metal cast product is provided with the bulkhead portion constituting part of the vehicle body. The bulkhead portion separates the vehicle cabin and the power unit room from each other at a position behind the motor in the vehicle front-rear direction.

When an impact load is applied to the vehicle from the front side of the vehicle, the motor receives this impact load. As a result, the motor may enter the vehicle cabin. It is therefore preferable to absorb the impact energy of the motor before the motor enters the vehicle cabin.

In this aspect, the front part in the vehicle front-rear direction of the motor is supported with respect to the vehicle body by the front mount portion. The front mount portion is configured to release the motor from a supported state when a load of the predetermined magnitude or more is applied from the front side of the vehicle.

On the other hand, the rear part in the vehicle front-rear direction of the motor is supported with respect to the vehicle body by the rear mount portion. The rear mount portion is supported at a position behind the front mount portion in the vehicle front-rear direction and above the front mount portion in the vehicle up-down direction.

Therefore, in this aspect, when an impact load of the predetermined magnitude or more is applied to the vehicle from the front side of the vehicle, the motor receives this impact load, so that the motor rotates about the rear mount portion as viewed in a vehicle width direction, and moves toward the bulkhead portion of the vehicle body.

The impact absorbing portion integral with the bulkhead portion is provided on the front side in the vehicle front-rear direction of the bulkhead portion. This impact absorbing portion is deformed when an impact load of the motor is applied from the front side of the vehicle. As a result, in this aspect, impact energy of the motor can be absorbed before the motor enters the vehicle cabin.

According to a vehicle body front structure of a second aspect, in the vehicle body front structure of the first aspect, the impact absorbing portion may include a front impact absorbing portion and a rear impact absorbing portion. The front impact absorbing portion includes a plurality of impact absorbing pieces whose thickness direction is a direction in which an impact load is applied. A plurality of reinforcing ribs is arranged in the rear impact absorbing portion so as to form a closed section as viewed in a vehicle up-down direction.

In the vehicle body front structure of the second aspect, the impact absorbing portion includes the front impact absorbing portion and the rear impact absorbing portion. The front impact absorbing portion includes the impact absorbing pieces whose thickness direction is the direction in which an impact load is applied. The impact absorbing pieces are flexibly deformed when an impact load of the motor is applied from the front side of the vehicle. The impact absorbing pieces thus contribute to absorption of the impact load.

On the other hand, the reinforcing ribs are arranged in the rear impact absorbing portion so as to form a closed section as viewed in the vehicle up-down direction. The rear impact absorbing portion thus has a higher rigidity against the impact load from the front side of the vehicle than the front impact absorbing portion.

Accordingly, in this aspect, the front part in the vehicle front-rear direction of the impact absorbing portion is more easily deformed by the impact load, and the rear part in the vehicle front-rear direction of the impact absorbing portion is less easily deformed by the impact load. As a result, it is possible to achieve both absorption of the impact load from the front side of the vehicle and reduction in entry of the motor into the vehicle cabin.

As described above, the vehicle body front structure according to the present disclosure is advantageous in that it can absorb the impact energy of the motor in the event of a frontal collision of the vehicle in which the motor is mounted on the front side of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view (a cross-sectional view taken along a I-I line in FIG. 2) showing a configuration of a front part of a vehicle to which a vehicle body front structure according to the present embodiment is applied;

FIG. 2 is a perspective view showing a configuration of a vehicle front portion of a vehicle body to which the vehicle body front structure according to the present embodiment is applied;

FIG. 3 is a plan view showing a configuration of a front mount portion of a motor mounted on a vehicle to which the vehicle body front structure according to the present embodiment is applied; and

FIG. 4 is a plan view showing a configuration of an impact absorbing portion provided in a vehicle body of the vehicle to which the vehicle body front structure according to the present embodiment is applied (a four-way arrow view in FIG. 1).

### DETAILED DESCRIPTION OF EMBODIMENTS

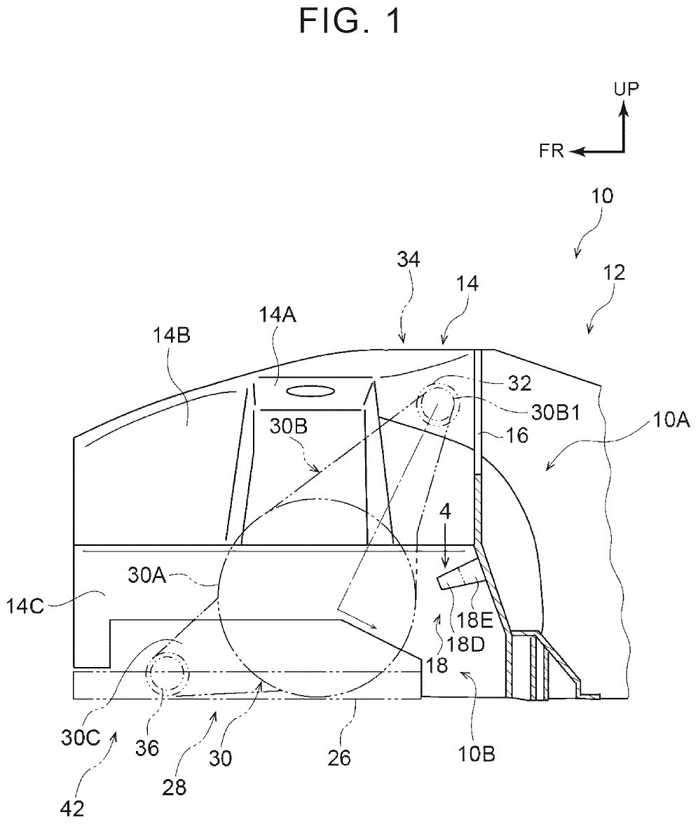

Hereinafter, an example of an embodiment of a vehicle body front structure according to the present disclosure will be described with reference to FIGS. 1 to 4. Furthermore, in the drawings, an arrow FR indicates a vehicle front side, an arrow UP indicates a vehicle upper side, and an arrow RH indicates a right side of the width direction of the vehicle.

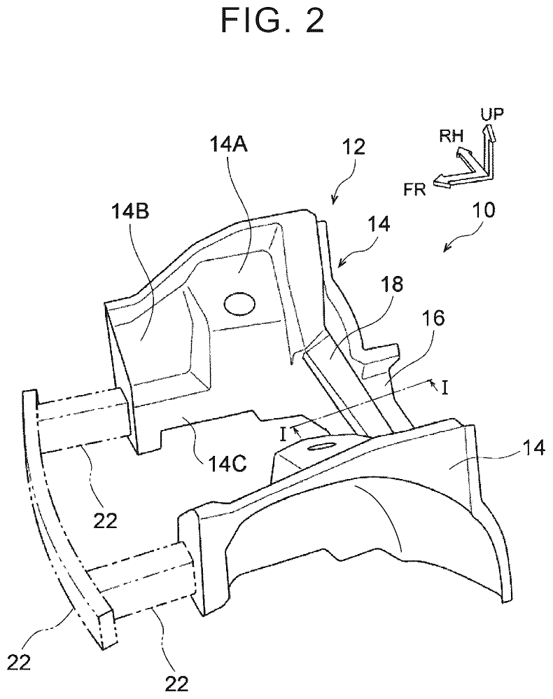

First, a schematic configuration of the “vehicle 10” to which the vehicle body structure according to the present embodiment is applied will be described with reference to FIG. 2. In the present embodiment, since the vehicle 10 is basically symmetrical, the configuration of the vehicle 10 on the right side in the vehicle width direction will be mainly described below, and the configuration of the vehicle width direction on the left side will not be described as appropriate.

The vehicle 10 includes a “front part 12” as a vehicle body that constitutes a portion on the vehicle front side, a center part that constitutes a central portion in the vehicle front-rear direction and includes a battery frame that holds a battery and a battery, and a rear part that constitutes a portion on the vehicle rear side. The front part 12 is made of aluminum die cast. The center part is not shown. The rear part is made of aluminum die cast and is not shown.

As also shown in FIG. 1, the front part 12 includes a pair of side component portions 14, a “bulkhead portion 16”, and an “impact absorbing portion 18”.

The side component portion 14 includes a suspension tower portion 14A, a wheel house portion 14B, and a side member portion 14C. The suspension tower portion 14A has a box shape in which a lower side of the vehicle is opened and a circular penetrating portion 20 is formed on an upper surface thereof, and supports an impact absorber (not shown). 15

The wheel house portion 14B is provided integrally with the suspension tower portion 14A and has a spherical shape capable of accommodating a part of a tire (not shown).

The side member portion 14C is disposed on the vehicle lower side of the 20 suspension tower portion 14A and is integrally provided with the suspension tower portion 14A and the wheel house portion 14B. The side member portion 14C extends in the vehicle front-rear direction, and has a U-shaped cross-section when viewed from the vehicle front side.

A crash box 22 is attached to a part of the side member portion 14C on the 25 vehicle front side, and the front end portions of the crash box 22 are connected to each other by bumper reinforcement 24 extending in the vehicle widthwise direction.

On the other hand, the bulkhead portion 16 extends in the vehicle vertical direction and the vehicle width direction with the thickness direction being the vehicle front-rear direction, and is arranged along the front edge portion of the center part described above, 30 and partitions the “vehicle cabin 10A” and the “power unit room 10B”. In addition, the bulkhead portion 16 connects the side component portions 14 to each other in the vehicle width direction. The bulkhead portion 16 is provided with an impact absorbing portion 18.

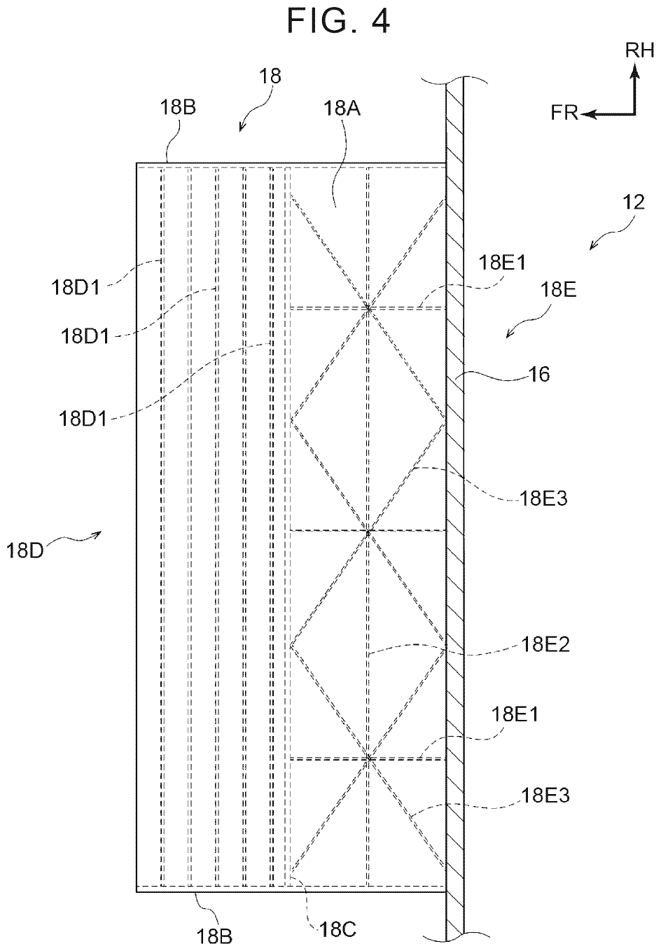

As also shown in FIG. 4, the impact absorbing portion 18 includes an upper wall portion 18A constituting a portion on the vehicle upper side and a pair of side wall portions 18B constituting a portion on the vehicle width-direction outer side, and extends from the bulkhead portion 16 to the vehicle front lower side.

More specifically, in the impact absorbing portion 18, the portion on the front side of the vehicle than the border wall portion 18C connecting the side wall portions 18B to each other in the vehicle front-rear-direction central portion is defined as a “front impact absorbing portion 18D”. More specifically, in the impact absorbing portion 18, a portion on the rear side of the vehicle than the border wall portion 18C is referred to as a “rear side impact absorbing portion 18E”.

The front impact absorbing portion 18D has a plate shape in which a plate thickness direction is a vehicle front-rear direction, extends in the vehicle width direction, and a thickness is thinner than the border wall portion 18C, and includes a plurality of “impact absorbing pieces 18D1” arranged at predetermined intervals in the vehicle front-rear direction. The impact absorbing pieces 18D1 extends from the upper wall portion 18A toward the lower side of the vehicle.

On the other hand, the rear impact absorbing portion 18E includes a plurality of “reinforcing rib 18E1”, a “reinforcing rib 18E2”, and a plurality of “reinforcing rib 18E3”. The plurality of “reinforcing ribbing 18E1” extend in the vehicle front-rear direction when viewed from the vehicle up-down direction. “Reinforcing ribs 18E2” extend in the vehicle-width direction. The plurality of “reinforcing rib 18E3” extend across the reinforcing rib 18E1 and the reinforcing rib 18E2. The reinforcing rib 18E1, the reinforcing rib 18E2, and the reinforcing rib 18E3 are arranged so as to constitute a triangular closed cross-section when viewed from the up-down direction of the vehicle. In the rear impact absorbing portion 18E configured as described above, the rigidity with respect to the impact load from the front side of the vehicle is higher than that of the front impact absorbing portion 18D.

Returning to FIG. 1, the suspension member 26 is attached to the vehicle lower side portion of the front part 12 configured as described above, and the “motor 28” is supported by the suspension member 26 from the vehicle lower side.

Specifically, the motor 28 is capable of applying a driving force to drive wheels (not shown) of the vehicle 10, and includes a motor case 30 constituting an outer shell thereof. The motor case 30 includes a main body portion 30A constituting a main part thereof, a pair of rear mounting piece portion 30B extending from the main body portion 30A to the vehicle rear upper side, and a front mounting piece portion 30C extending from the main body portion 30A to the vehicle front lower side.

More specifically, the support shaft portion 30B1 protrudes from the distal end-side portion of the rear mounting piece portion 30B to the vehicle-width-direction outer side. The support shaft portion 30B1 is rotatably supported around the vehicle width-direction in the vehicle upper side of the wheel house portion 14B and the vehicle front side of the bulkhead portion 16 in the side component portion 14 via the rear mount member 32. Hereinafter, the assembly of the support shaft portion 30B and the rear mount member 32 will be referred to as a “rear mount portion 34”.

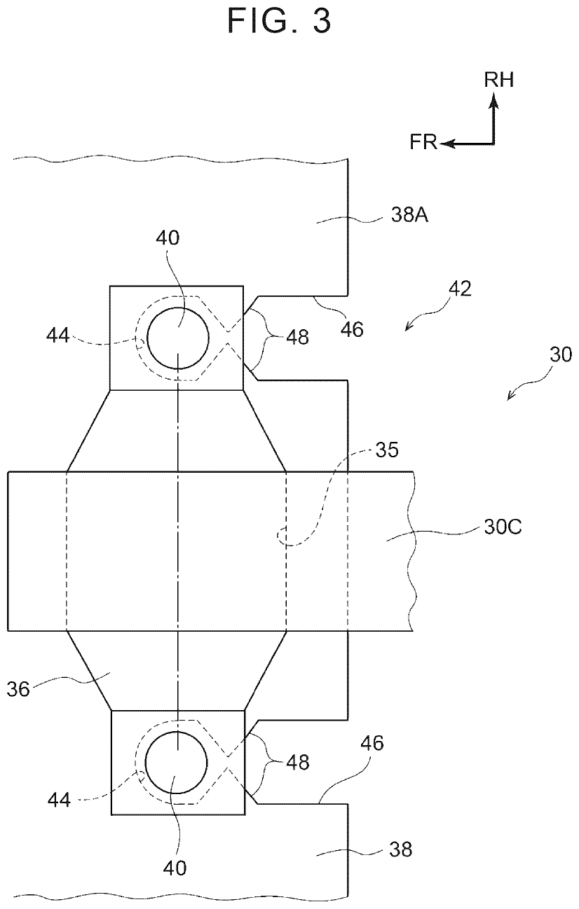

On the other hand, as shown in FIG. 3, a penetrating portion 35 is formed at a distal end portion of the front mounting piece portion 30C, and a connecting pin 36 is inserted through the penetrating portion 35 in the vehicle-width direction. Both end portions of the connecting pin 36 are attached to the front mount member 38 provided at the vehicle front side portion of the suspension member 26 via a bolt 40 and a nut (not shown). In the following description, the assembly of the connecting pin 36 and the front mount member 38 will be referred to as a “front mount portion 42”. Further, the above-described rear mount portion 34 is located on the vehicle rear side and the vehicle upper side of the front mount portion 42 when viewed in the vehicle width direction.

Specifically, a penetrating portion 44 through which the shaft portion of the bolt 40 can be inserted in the vehicle vertical direction is formed in the upper wall portion constituting the vehicle upper side portion of the front mount member 38, and a part of the vehicle rear side at the peripheral edge portion of the penetrating portion 44 is opened. On the vehicle rear side of the penetrating portion 44, a slit portion 46 extending in the vehicle front-rear direction continuously with the penetrating portion 44 and having the vehicle rear side opened is formed. The length (width) of the slit portion 46 in the vehicle width direction is set to a length through which the shaft portion of the bolt 40 can be inserted.

Further, a pair of fuse portions 48 adjacent to each other in the vehicle width direction is provided at a boundary portion between the penetrating portion 44 and the slit portion 46, that is, on the vehicle rear side of the shaft portion of the bolt 40. The fuse portions 48 have a substantially triangular plate shape that is reduced in width toward the center side in the vehicle width direction of the penetrating portion 44 and the slit portion 46 when viewed from the vehicle vertical direction.

The fuse portion 48 is plastically deformed when a load having a magnitude of a predetermined value or more is input from the bolt 40. In a state in which the fuse portion 48 is plastically deformed, relative displacement of the bolt 40 toward the vehicle rear side with respect to the front mount member 38 is allowed.

In other words, the front mount portion 42 can release the motor 28 from the support state by receiving a load of a predetermined magnitude or more from the front side of the vehicle.

### Actions and Effects of Embodiment

Next, actions and effects of the embodiment will be described.

In the present embodiment, as shown in FIG. 1, a motor 28 is disposed on the front side of the vehicle, and a driving force is applied to the drive wheels of the vehicle 10 by the motor 28. Further, the front part 12 made of a metallic cast product is provided with a bulkhead portion 16 constituting a part thereof, and the bulkhead portion 16 partitions the vehicle cabin 10A and the power unit room 10B on the vehicle rear side of the motor 28.

Incidentally, when an impact load is inputted to the vehicle 10 from the vehicle front side, the motor 28 may enter the inside of the vehicle cabin 10A by receiving the impact load from the motor 28. Therefore, it is preferable to be able to absorb the impact-energy of the motor 28 before the motor 28 enters the inside of the vehicle cabin 10A.

Here, in the present embodiment, as also shown in FIG. 3, the front portion of the motor 28 on the vehicle front side is supported by the front mount portion 42 with respect to the front part 12. The front mount portion 42 can release the motor 28 from the support state by inputting a load having a predetermined magnitude or more from the front side of the vehicle.

On the other hand, a portion of the motor 28 on the vehicle rear side is supported by the rear mount portion 34 with respect to the front part 12, and the rear mount portion 34 is supported by the vehicle rear side and the vehicle upper side of the front mount portion 42.

Therefore, in the present embodiment, when an impact load of a predetermined magnitude or more is input to the vehicle 10 from the front side of the vehicle, the motor 28 receives the impact load. As a result, the motor 28 rotates around the rear mount portion 34 as viewed in the vehicle width direction and moves toward the bulkhead portion 16 side of the front part 12.

An impact absorbing portion 18 is provided integrally with the bulkhead portion 16 on the vehicle front side of the bulkhead portion 16, and the impact absorbing portion 18 is deformed when an impact load of the motor 28 is input from the vehicle front side. As a consequence, in the present embodiment, the impact-energy of the motor 28 can be absorbed before the motor 28 enters the inside of the vehicle cabin 10A.

Further, in the present embodiment, as shown in FIG. 4, the impact absorbing portion 18 includes a front impact absorbing portion 18D and a rear impact absorbing portion 18E. The front impact absorbing portion 18D includes a plurality of impact absorbing pieces 18D1 whose plate thickness direction is an input direction of an impact load (an input assumed direction). These impact absorbing pieces 18D1 are flexibly deformed by receiving an impact load of the motor 28 from the front side of the vehicle, and contribute to absorbing the impact load.

On the other hand, a plurality of reinforcing ribs 18E1, reinforcing ribs 18E2, and reinforcing ribs 18E3 are arranged in the rear impact absorbing portion 18E so as to form a closed cross section when viewed from the up-down direction of the vehicle. The rear impact absorbing portion 18E has higher stiffness with respect to the impact load from the front side of the vehicle than the front impact absorbing portion 18D.

Therefore, in the present embodiment, the vehicle front portion of the impact absorbing portion 18 is easily deformed by the impact load from the vehicle front side, and the vehicle rear portion of the impact absorbing portion 18 is hardly deformed by the impact load from the vehicle front side. Consequently, it is possible to both absorb the impact load from the front side of the vehicle and suppress the entry of the motor 28 into the inside of the vehicle cabin 10A.

As described above, in the present embodiment, in the vehicle 10 in which the motor 28 is mounted on the vehicle front side, the collision energy of the motor 28 at the time of the front collision can be absorbed.

What is claimed is:

1. A vehicle body front structure comprising:
a motor disposed on a front side of a vehicle and configured to apply a driving force to a drive wheel;
a bulkhead portion constituting part of a vehicle body that is a metal cast product, and separating a vehicle cabin and a power unit room from each other at a position behind the motor in a vehicle front-rear direction;
a front mount portion configured to support a front part in the vehicle front-rear direction of the motor with respect to the vehicle body, and configured to release the motor from a supported state when a load of a predetermined magnitude or more is applied from the front side of the vehicle;
a rear mount portion configured to support a rear part in the vehicle front-rear direction of the motor with respect to the vehicle body at a position behind the front mount portion in the vehicle front-rear direction and above the front mount portion in a vehicle up-down direction; and
an impact absorbing portion that is provided integrally with the bulkhead portion on a front side in the vehicle front-rear direction of the bulkhead portion and that is configured to be deformed when an impact load is applied from the front side of the vehicle.

2. The vehicle body front structure according to claim 1, wherein the impact absorbing portion includes a front impact absorbing portion and a rear impact absorbing portion, the front impact absorbing portion including a plurality of impact absorbing pieces whose thickness direction is a direction in which an impact load is applied, and a plurality of reinforcing ribs being arranged in the rear impact absorbing portion so as to form a closed section as viewed in a vehicle up-down direction.
